(19) United States
(12) Patent Application Publication
(10) Pub. No.: US 2015/0264912 A1
(43) Pub. Date: Sep. 24, 2015

(54) HINGED INSECTICIDE STRIP

(71) Applicant: Y-TEX CORPORATION, CODY, WY (US)

(72) Inventor: Michael G. FLETCHER, CODY, WY (US)

(21) Appl. No.: 14/621,946

(22) Filed: Feb. 13, 2015

Related U.S. Application Data
(60) Provisional application No. 61/955,969, filed on Mar. 20, 2014.

(51) Int. Cl. A01M 1/20

(52) U.S. Cl. CPC A01M 1/2005

(57) ABSTRACT

An insecticide-carrying device is provided and may include a first insecticide-carrying strip and a second insecticide carrying strip. The second insecticide carrying strip may be rotatably coupled to the first insecticide-carrying strip to permit relative movement between the first insecticide-carrying strip and the second insecticide-carrying strip.

### CROSS-REFERENCE TO RELATED APPLICATIONS

This application claims the benefit of U.S. Provisional Application No. 61/955,969, filed Mar. 20, 2014. The entire disclosure of the above application is incorporated herein by reference.

### FIELD

The present disclosure relates to an insecticide-carrying device for treating livestock and in particular to a multi-piece insecticide-carrying device.

### BACKGROUND

This section provides background information related to the present disclosure which is not necessarily prior art.

It is well known in the livestock industry to impregnate articles such as tags with an insecticide. Generally, such tags are attached to the livestock in order to control biting and nuisance flies, and other ectoparasites. For example, an insecticide-carrying tag may be applied to one or both ears of the animal. As such, conventional insecticide-carrying tags typically include a tag and a tag hanger. An example of a known insecticide tag is shown in U.S. Pat. No. 4,581,834.

Insecticide-carrying devices are also used in and around livestock feeders and other locations where livestock might otherwise congregate to likewise control ectoparasites. For example, an insecticide-carrying bag may be hung from, or otherwise fastened to, a livestock feeder. While such bags adequately support and position an insecticide material near livestock feeders and other locations where livestock congregate, such bags are cumbersome and often are formed from materials that are susceptible to weather conditions, thereby reducing the effectiveness of the device.

### SUMMARY

This section provides a general summary of the disclosure, and is not a comprehensive disclosure of its full scope or all of its features.

An insecticide-carrying device is provided and may include a first insecticide-carrying strip and a second insecticide carrying strip. The second insecticide carrying strip may be rotatably coupled to the first insecticide-carrying strip to permit relative movement between the first insecticide-carrying strip and the second insecticide-carrying strip.

In another configuration, an insecticide-carrying device is provided and may include a first insecticide-carrying strip and a second insecticide carrying strip. The second insecticide carrying strip may be moveably attached to the first insecticide-carrying strip to permit relative movement between the first insecticide-carrying strip and the second insecticide-carrying strip.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an insecticide-carrying device in accordance with the principles of the present disclosure shown in a first configuration;

FIG. 2 is a perspective view of the insecticide-carrying device of FIG. 1 in a second configuration;

FIG. 3 is a perspective view of the insecticide-carrying device of FIG. 1 in a third configuration;

FIG. 4 is an exploded view of the insecticide-carrying device of FIG. 1;

FIG. 5 is a partial front view of the insecticide-carrying device of FIG. 1; and

FIG. 6 is a cross-sectional view of a portion of the insecticide-carrying device of FIG. 1 taken along the line 6-6 of FIG. 5.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

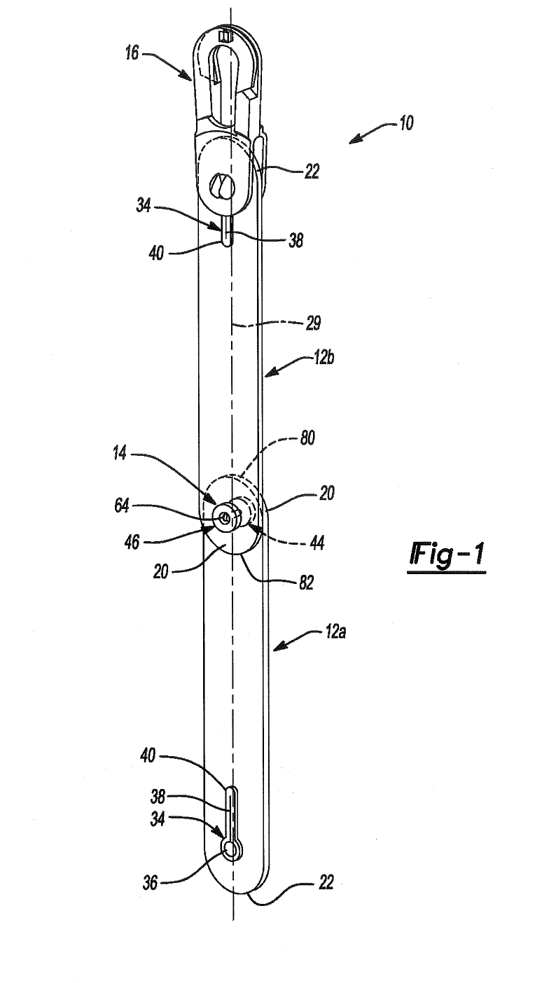

Referring to FIG. 1, a perspective view of a hinged insecticide-carrying device 10 is provided. The device 10 may include a first insecticide-carrying strip 12a, a second insecticide-carrying strip 12b, a hinge assembly 14, and a clip or hanger 16. While the device 10 is generally shown and described herein as including first and second insecticide-carrying strips 12a, 12b, the device 10 may include more than two insecticide-carrying strips.

In one configuration, the first insecticide-carrying strip 12a may be similar to the insecticide-carrying strip described in assignee's commonly-owned U.S. patent application Ser. Nos. 13/799,685 and 13/799,468, filed on Mar. 13, 2013, the disclosures of which are incorporated herein by reference. Further, the second insecticide-carrying strip 12b may be substantially similar to the first insecticide-carrying strip 12a, and preferably identical thereto. Accordingly, references herein to the strip 12 will be understood to apply equally to the first and second insecticide-carrying strips 12a, 12b, and like reference numerals will be used to describe like features.

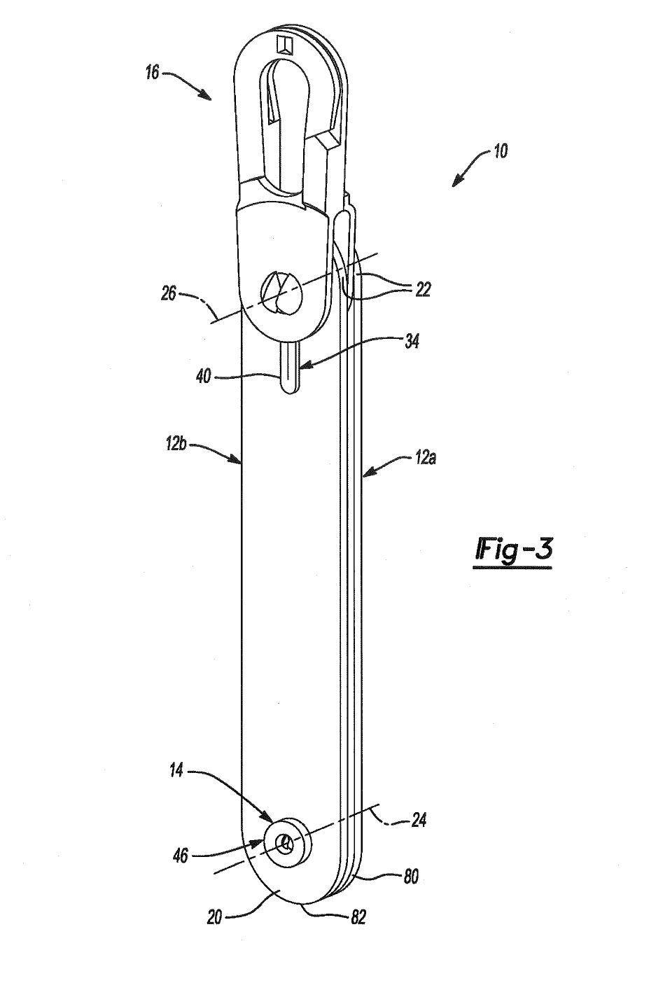

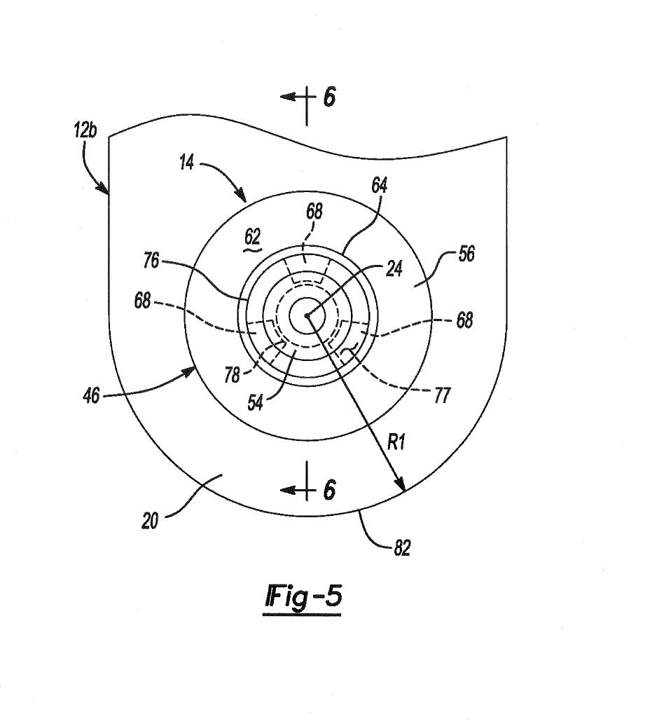

The strip 12 includes an elongated substantially flat strap having first and second rounded end portions 20 and 22, respectively. With reference to FIGS. 3 through 5, the first and second rounded end portions 20 and 22 may define a radius of curvature R1, R2, respectively, extending from an axis 24 and 26, respectively. The first end portion 20 of the first insecticide-carrying strip 12a may be an upper-end portion, and the second end portion 22 of the first insecticide-carrying strip 12a may be a lower-end portion. Conversely, the first end portion 20 of the second insecticide-carrying strip 12b may be a lower-end portion, and the second end portion 22 of the second insecticide-carrying strip 12b may be an upper-end portion. As illustrated in FIG. 3, in the assembled configuration, the first end portion 20 of the first insecticide-carrying strip 12a may be pivotably coupled to the first end portion 20 of the second insecticide-carrying strip 12b, for rotation about an axis 24.

As illustrated in FIG. 1, the strip 12 generally defines a central longitudinal axis 29 extending between the end portions 20 and 22. In one configuration, the strip 12 is injection molded as a monolithic member that is approximately six (6) inches in length, one and one quarter (1.25) inches in width, and approximately one sixteenth ( 1/16) of an inch thick. The strip 12 can be made of a flexible, relatively soft material such as, for example, polyvinyl chloride, that is suitable for being impregnated with an insecticide. While polyvinyl chloride is disclosed for use in manufacturing the strip 12, other suitable materials may be used. The resulting large surface area of the strip 12 allows the strip 12 to carry a relatively large quantity of insecticide, thereby improving long term efficacy of the strip 12.

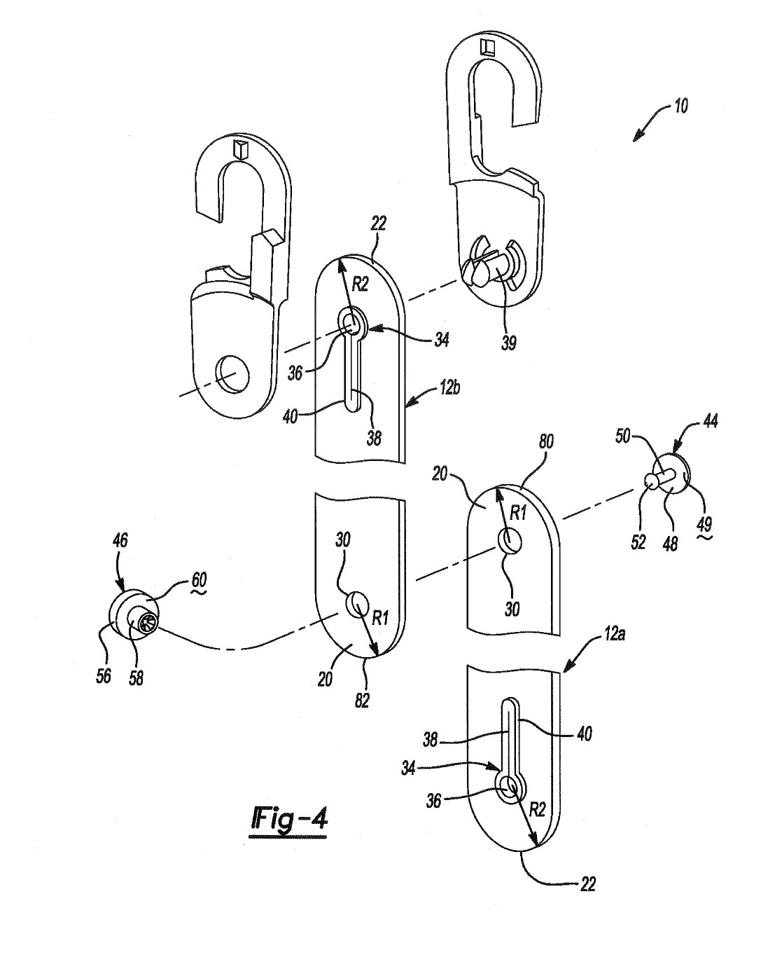

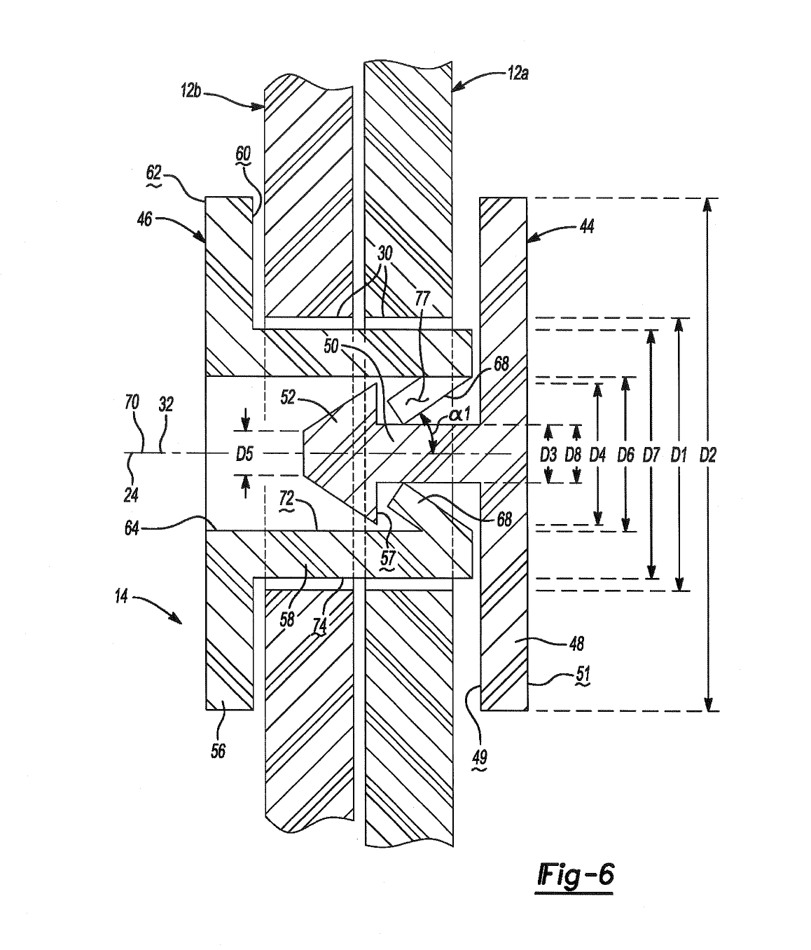

As illustrated in FIGS. 4 and 6, the first end portion 20 of the strip 12 may include an aperture 30. In one configuration, the aperture 30 is substantially circular, having a diameter D1 and defining an axis of rotation 32. The diameter D1 may be between approximately three (3) millimeters and eleven (11) millimeters. In one configuration, the diameter D1 may be substantially equal to approximately eight (8) millimeters. The axis of rotation 32 may be substantially aligned with the axis 24 of the first end portion 20 of the first and second insecticide-carrying strips 12a, 12b.

The second end portion 22 of the strip 12 may include a “key-hole” shaped aperture 34 having a circular hole 36 and a downwardly extending slit 38 that is in communication with the circular hole 36. Note, the strip 12 may be formed during the injection molding process with a thin frangible web connecting the adjoining sides of the slit 38 of aperture 34.

The circular hole 36 of the aperture 34 may be centered on the longitudinal axis 29 of the strip 12 with the slit 38 extending along the axis 29. A diameter of the hole 36 may be sized to be slightly larger than a diameter of an attachment feature 39 of the hanger 16 (FIG. 4), such that the strip 12 can pivot or otherwise rotate relative to the hanger 16, as will be described in more detail below. In addition, a length of the slit 38 along the axis 29 may be designed so that, when combined with the diameter of the hole 36, the combined length L2 is approximately equal to or slightly greater than a dimension (e.g., a diameter) of the flange portion of a male component of a standard two-piece livestock ID tag (not shown). In this way, the strip 12 can be made with the same tooling used to manufacture the insecticide-carrying strip described in Assignee's above-identified applications, Ser. No. 13/799,685 and Ser. No. 13/799,468, which as described therein, is designed for attachment to standard one-piece and two-piece livestock ID tags.

Alternatively, the aperture 34 in the second end portion 22 of the strip 12 may comprise a circular hole 36 only, without an adjoining slit portion.

The boundary of the key-hole shaped aperture 34 is completely closed and may be reinforced by the formation of a thickened border area 40 immediately surrounding the entire boundary of the aperture 34. The reinforced border area 40 may be formed on both sides of the strip 12 so that the overall thickness of the plastic material in the border area 40 is approximately twice the thickness of the remainder of the strip 12. The increased thickness of the strip 12 at the boundary of the aperture 34 reinforces the strip 12 and therefore protects against tearing of the strip 12 at the aperture 34. In addition, the boundary of the aperture 30 in the first end portion 20 of the strip 12 may be similarly reinforced with a thickened border area (not shown) to further protect against tearing of the strip 12 at aperture 30 as well.

The strip 12 may be impregnated with insecticide compounds having a variety of EPA-approved active ingredients, including without limitation, pyrethroid, permethrin, zeta-cypermethrin, ivermectin, avermectin, abamectin, milbemectin, diazinon and chlorpyrifos, or any combination thereof.

The hinge assembly 14 may include a male component 44 and a female component 46. The male component 44 may include a first flange portion 48, a stem portion 50, and a head portion 52. The first flange portion 48 may define a substantially circular disk having a diameter D2 and including a first or inner surface 49 and a second or outer surface 51. The diameter D2 is substantially greater than the diameter D1 of the aperture 30.

The stem portion 50 may be integrally and monolithically formed with the first flange portion 48. The stem portion 50 may be substantially cylindrical and may include an outer diameter D3. Further, the stem portion 50 may be concentrically located relative to the first flange portion 48. The head portion 52 may extend from the stem portion 50 such that the stem portion 50 extends between the first flange portion 48 and the head portion 52. In one configuration, the head portion 52 includes a frustoconical shape, defining a base diameter D4 and a tip diameter D5. The diameter D4 is larger than the tip diameter D5 and is larger than the diameter D3 of the stem portion 50, such that the head portion 52 defines a stop surface 57 that is substantially parallel to the inner surface 49 of the first flange portion 48. In this regard, the tip diameter D5 may be substantially equal to the diameter D3 of the stem portion 50, and the diameter D4 may be between approximately twenty percent and fifty percent larger than each of the diameters D3 and D5. As will be explained in more detail below, the foregoing configuration of the male component 44 allows for easier assembly and coupling of the male component 44 to the female component 46.

The female component 46 may include a second flange portion 56 and a mounting portion 58. The second flange portion 56 may define a substantially circular disk including a first or inner surface 60, a second or outer surface 62, and a substantially circular through-hole or aperture 64. The aperture 64 may define a diameter D6 and may be concentrically located relative to the second flange portion 56.

The mounting portion 58 may define a substantially cylindrical hub, including a plurality of flexible locking elements 68. In one configuration, the mounting portion 58 may be integrally and monolithically formed with the second flange portion 56. In this regard, the mounting portion 58 may be concentrically located relative to the second flange portion 56 and may extend from the inner surface 60 of the second flange portion 56 along a second longitudinal axis 70. The mounting portion 58 may include an outer surface 74 defining a diameter D7 that is slightly less than the diameter D1 of the aperture 30.

The locking elements 68 may extend from an inner surface 72 of the mounting portion 58. In one configuration, the locking elements 68 define a profile having a wide base 76 that narrows down to a tip 78. The locking elements 68 may include a concave surface 77 generally facing the second longitudinal axis 70. As illustrated in FIG. 6, the concave surface 77 defines an angle α with the second longitudinal axis 70. The angle α may be between ten degrees (10°) and sixty degrees (60°). In one configuration, the angle α may be substantially equal to forty-five degrees (45°). The concave surfaces 77 of the locking elements 68 may collectively define a frustoconical shape, and the tips 78 of the locking elements 68 may collectively define a substantially circular opening having a diameter D8. The diameter D8 may be less than the base diameter D4 of the head portion 52 and substantially equal to or slightly less than diameter D3 of the stem portion 50. While the mounting portion 58 is shown and described herein as including three locking elements 68, the mounting portion 58 may include more or less than three locking elements within the scope of the present disclosure.

The hanger 16 may be used for pivotably supporting the first insecticide-carrying strip 12a relative to a feeding apparatus or other suitable structure. In this regard, as will be described in more detail below, the hanger 16 may be pivotably coupled to the first insecticide-carrying strip 12a. One example of a hanger 16 is described in assignee's commonly-owned U.S. patent application Ser. No. 13/707,154 filed on Dec. 6, 2012, the disclosure of which is incorporated herein by reference.

To assemble the device 10, the mounting portion 58 of the female component 46 may be positioned within the apertures 30 of the first and second insecticide-carrying strips 12a and 12b when the apertures 30 of the respective strips 12a, 12b are aligned with one another. The male component 44 may positioned relative to the female component 46 such that the inner surface 49 of the male component 44 faces the inner surface 60 of the female component 46. The male component 44 may be coupled to the female component 46 by extending the head portion 52 through and between the locking elements 68, and into the aperture 64. In this way, the locking elements 68 flex or otherwise bend to receive the base diameter D4 of the head portion 52 until the tips 78 of the locking elements 68 are adjacent the stop surface 57 of the head portion. The stop surface 57 and the diameter D4 of the head portion 52 cooperate to restrict the male component 44 from dislodging or otherwise uncoupling from the female component 46. In so doing, the insecticide-carrying strips 12a, 12b are retained between the first flange portion 48 and the second flange portion 56 and are permitted to rotate relative to one another about the outer surface 74 of the mounting portion 58.

The attachment feature 39 of the hanger 16 may be positioned within the hole 36 of the second insecticide-carrying strip 12b. Accordingly, the second insecticide-carrying strip 12b is rotatably coupled to the hanger 16 and the first and second insecticide-carrying strips 12a, 12b are rotatably or otherwise movably coupled to one another via the hinge assembly 14.

As discussed above and illustrated in FIG. 6, in the assembled configuration, the axis of rotation 32 may be substantially aligned with the axis 24 and with the axis 70 of the second mounting portion 58. Accordingly, as the first insecticide-carrying strip 12a rotates or pivots relative to the second insecticide-carrying strip 12b, the rounded first end portion 20 may define portions of a substantially circular shape.

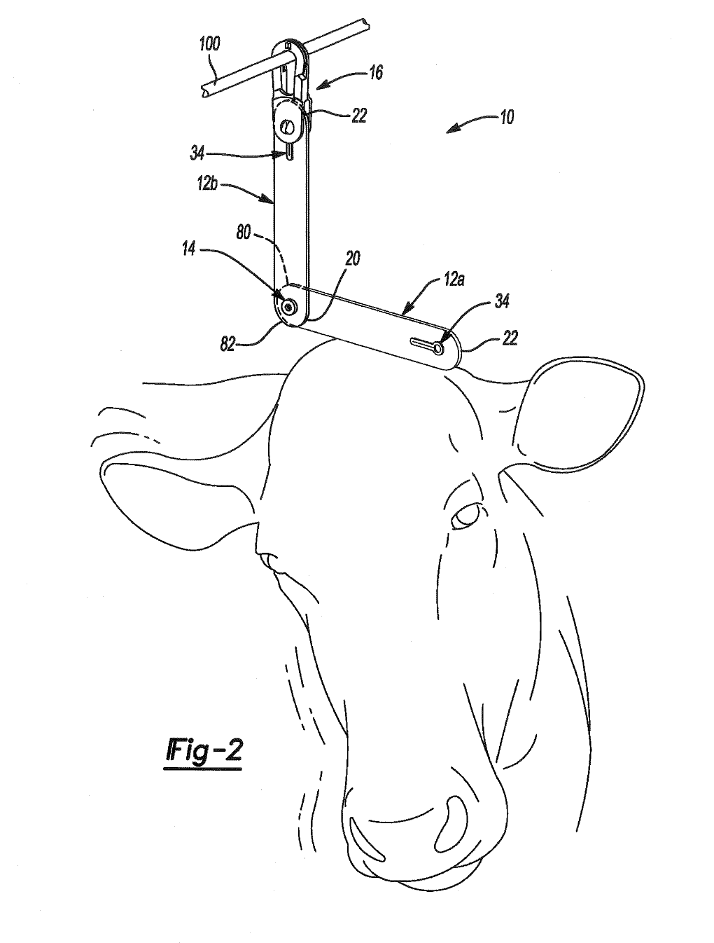

As illustrated in FIG. 1, in a first position, the first end portion 20 of the first insecticide-carrying strip 12a and the first end portion 20 of the second insecticide-carrying strip 12b can collectively define approximately three hundred sixty degrees (360°) of a circle. As illustrated in FIG. 2, in a second position, the first end portion 20 of the first insecticide-carrying strip 12a and the first end portion 20 of the second insecticide-carrying strip 12b can collectively define approximately two hundred seventy degrees (270°) of a circle. Finally, as illustrated in FIG. 3, in a third position, the first end portion 20 of the first insecticide-carrying strip 12a and the first end portion 20 of the second insecticide-carrying strip 12b can collectively define approximately one hundred eighty degrees (180°) of a circle. Stated another way, in an assembled configuration, a peripheral surface or edge 80 of the first end portion 20 of the first insecticide-carrying strip 12a does not extend beyond, or otherwise overhang, a peripheral surface or edge 82 of the second insecticide-carrying strip 12b and the first end portion 20 of the second insecticide-carrying strip 12b does not extend beyond, or otherwise overhang, the perimeter of the first insecticide-carrying strip 12a. In this way, the device 10 is able to reduce the tendency for objects, such as livestock fur or another device 10, to snag on, or otherwise get caught between, the edges 80, 82 of the first and second insecticide-carrying strips 12a, 12b, as the first insecticide-carrying strip 12a rotates relative to the second insecticide-carrying strip 12b. In operation, the device 10 may be attached to an external structure 100 such as a livestock feeding apparatus or the like. Namely, the hanger 16 may be attached to the external structure 100 to attach the device 10 to the external structure 100.

As described above, the device 10 is rotatably attached to the hanger 16 such that the second insecticide-carrying strip 12b is permitted to rotate about axis 26 and relative to the attachment feature 39 of the hanger 16.

The first insecticide-carrying strip 12a is likewise rotatably attached to the second insecticide-carrying strip 12b to permit the first insecticide-carrying strip 12a to rotate about axis 24 relative to the second insecticide-carrying strip 12b. Namely, the first insecticide-carrying strip 12a is rotatably attached to the second insecticide-carrying strip 12b via the hinge assembly 14.

When an animal uses the feeding apparatus, the animal inserts its head into the feeding apparatus and, in so doing, encounters the device 10. For example, the head of the animal may engage one or both of the first insecticide-carrying strip 12a and the second insecticide-carrying strip 12b. Contacting one or both of the strips 12a, 12b causes the insecticide impregnated in the strips 12a, 12b to be transferred onto the animal.

The forces associated with the animal's head contacting one or both of the strips 12a, 12b may cause one or both of the strips 12a, 12b to move relative to one another and relative to the external structure 100 and/or hanger 16. For example, if the head of the animal contacts the first insecticide-carrying strip 12a, a force may be applied to the first insecticide-carrying strip 12a, thereby causing the first insecticide-carrying strip 12a to rotate relative to the second insecticide-carrying strip 12b, as the second insecticide-carrying strip 12b is rotatably attached to the first insecticide-carrying strip 12a at the hinge assembly 14. The foregoing operation of the device 10 is shown in FIG. 2, whereby the second insecticide-carrying strip 12b is rotated relative to the first insecticide-carrying strip 12a about the hinge assembly 14.

If the force exerted on the second insecticide-carrying strip 12b is sufficient and/or is likewise applied to the first insecticide-carrying strip 12a, the first insecticide-carrying strip 12a may likewise rotate relative to the external structure 100 via the hanger 16. Namely, the first insecticide-carrying strip 12a may rotate about the attachment feature 39 of the hanger 16, thereby causing the first insecticide-carrying strip 12a and the second insecticide-carrying strip 12b to rotate relative to the hanger 16 and relative to the external device 100.

Allowing relative movement between the first insecticide-carrying strip 12a, the second insecticide-carrying strip 12b, the hanger 16, and the external device 100 allows the device 10 to contact an animal's head when using the feeding apparatus while concurrently permitting the device 10 to flex and move in response to forces received from the animal's head. Allowing the device 10 to rotate and move in response to a force applied thereto protects the device 10 and decreases the likelihood that any portion of the device 10 will tear in response to receipt of such a force. In addition, the pivoting action of the device 10 also enhances the effectiveness of insecticide transfer from the strips 12 to the animal.

Furthermore, as will be appreciated by those skilled in the art, the configuration of the device 10 as two identical strips 12a and 12b hinged together, each of which approximately 6 inches in length, is significantly easier and less expensive to mold than a comparable single strip approximately 10-11 inches in length. Moreover, the hinged design of the present device 10 also simplifies packaging for the device 10. In particular, the present device 10 can be placed into the orientation shown in FIG. 3, wherein the first strip 12a overlays the second strip 12b. In this configuration, the overall size of the device 10 is minimized which in turn reduces the packaging costs for the device 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An insecticide-carrying device comprising:
a first insecticide-carrying strip; and
a second insecticide carrying strip rotatably coupled to said first insecticide-carrying strip to permit relative movement between said first insecticide-carrying strip and said second insecticide-carrying strip.

2. The insecticide-carrying device of claim 1, wherein said first insecticide-carrying strip is rotatable relative to said second insecticide-carrying strip about a hinge.

3. The insecticide-carrying device of claim 2, wherein said hinge includes a male component coupled to a female component.

4. The insecticide-carrying device of claim 3, wherein each of said first insecticide-carrying strip and said second insecticide-carrying strip includes an aperture, said aperture aligned to receive a portion of said hinge.

5. The insecticide-carrying device of claim 4, wherein one of said first insecticide-carrying strip and said second insecticide-carrying strip includes an attachment feature operable to attach said one of said first insecticide-carrying strip and said second insecticide-carrying strip to an external structure.

6. The insecticide-carrying device of claim 5, wherein said attachment feature is formed on an opposite end of said one of said first insecticide-carrying strip and said second insecticide-carrying strip than said aperture.

7. The insecticide-carrying device of claim 6, wherein said attachment feature is an aperture formed through said one of said first insecticide-carrying strip and said second insecticide-carrying strip.

8. The insecticide-carrying device of claim 5, wherein said attachment feature is an aperture formed through said one of said first insecticide-carrying strip and said second insecticide-carrying strip.

9. The insecticide-carrying device of claim 1, wherein said second insecticide-carrying strip is configured substantially identically to said first insecticide-carrying strip.

10. The insecticide-carrying device of claim 9, wherein said second insecticide-carrying strip can be positioned to overlay said first insecticide-carrying strip.

11. An insecticide-carrying device comprising:
a first insecticide-carrying strip; and
a second insecticide carrying strip moveably attached to said first insecticide-carrying strip to permit relative movement between said first insecticide-carrying strip and said second insecticide-carrying strip.

12. The insecticide-carrying device of claim 11, wherein said first insecticide-carrying strip is rotatable relative to said second insecticide-carrying strip about a hinge.

13. The insecticide-carrying device of claim 12, wherein said hinge includes a male component coupled to a female component.

14. The insecticide-carrying device of claim 13, wherein each of said first insecticide-carrying strip and said second insecticide-carrying strip includes an aperture, said aperture aligned to receive a portion of said hinge.

15. The insecticide-carrying device of claim 14, wherein one of said first insecticide-carrying strip and said second insecticide-carrying strip includes an attachment feature operable to attach said one of said first insecticide-carrying strip and said second insecticide-carrying strip to an external structure.

16. The insecticide-carrying device of claim 15, wherein said attachment feature is formed on an opposite end of said one of said first insecticide-carrying strip and said second insecticide-carrying strip than said aperture.

17. The insecticide-carrying device of claim 16, wherein said attachment feature is an aperture formed through said one of said first insecticide-carrying strip and said second insecticide-carrying strip.

18. The insecticide-carrying device of claim 15, wherein said attachment feature is an aperture formed through said one of said first insecticide-carrying strip and said second insecticide-carrying strip.

19. The insecticide-carrying device of claim 11, wherein said second insecticide-carrying strip is configured substantially identically to said first insecticide-carrying strip.

20. The insecticide-carrying device of claim 19, wherein said second insecticide-carrying strip can be positioned to overlay said first insecticide-carrying strip.
